(19) United States
(12) Patent Application Publication
(10) Pub. No.: US 2006/0044580 A1
(43) Pub. Date: Mar. 2, 2006

(54) Image forming apparatus with key macro function, control method for the same, control program for implementing the method, and storage medium storing the program

(75) Inventor: Tadaaki Maeda, Kawasaki-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/210,269

(22) Filed: Aug. 23, 2005

(30) Foreign Application Priority Data
Aug. 23, 2004 (JP) 2004-242832(PAT.)

(51) Int. Cl. H04N 1/60; G06K 15/02

(52) U.S. Cl. 358/1.9; 358/1.2

(57) ABSTRACT

An image forming apparatus which is capable of improving the usability of a key macro function provided therein. A plurality of operating keys of the operating section 200 respectively inputs a plurality of pieces of operation information. The inputted plurality of pieces of operation information are registered as a key macro via macro registration mode key 401. It is determined whether the registered key macro is properly executable, before the registered key macro is executed.

### BACKGROUND OF THE INVENTION

1. Field of the Invention

The present invention relates to an image forming apparatus with a key macro function, a control method for the same, a control program for implementing the method, and a storage medium storing the program, and in particular to an image forming apparatus that produces a desired printout according to various settings, a control method for the same, a control program for the same for implementing the method, and a storage medium storing the program.

2. Description of the Related Art

A conventional multi function printer (MFP) is collectively provided with functions such as a print function, a facsimile transmission/reception function, a transmission/reception function for scanned images, and an electronic mail transmission/reception function in addition to a copy function, which improves the efficiency of office work.

More functions are being incorporated in MFPs to further improve the efficiency of office work, resulting in an increase in the number of items that need to be set by the user on an operating section of the MFP. For this reason, there is a function called a “key macro” where key operations made by the user are recorded, a single operating key is assigned to the recorded contents, and the recorded key operations can thereafter be recalled and executed by operating the assigned operating key. By using this key macro function, it is possible to perform complex operations that normally require a plurality of key operations with a single key operation, which improves the operability of the MFP.

MFPs provided with a key macro function include an MFP that uses key codes, which are generated when operating keys are pressed, to register the types and order of pressing of all the pressed operating keys that are sequentially pressed as a key macro, and executes the key macro when a recall key corresponding to the key macro is pressed (see, for example, Japanese Laid-Open Patent Publication (Kokai) No. H05-246111), and an MFP that registers a key macro while storing an order of key operations by pressing operating keys in the same manner as in actual operation, that is, in an intermittent manner, thereby avoiding registration errors for the key macro (see, for example, Japanese Laid-Open Patent Publication (Kokai) No. H08-329338).

However, the prior art does not contemplate the case where an error occurs during execution of the key macro function provided in such a conventional MFP even if the key macro has been properly registered. Therefore, if a registered key macro is executed in an apparatus such as an MFP that uses consumables, when the consumables required for the process according to the key macro have run out, it will no longer be possible to execute the key macro that was executable when the key macro was registered. More specifically, in such a case, the key macro is executed until the stage where the process using consumables is executed is reached, and then an error will occur, resulting in the process being interrupted.

Moreover, when executing a registered key macro uses an external resource, such as when transmitting a facsimile, transmitting or receiving electronic mail, or transmitting or receiving data via a LAN or the Internet, the key macro will not be executable when the required external resource is not operating even though the key macro was executable when registered. More specifically, in such a case, the key macro is executed until the stage where the process using the external resource is executed is reached, and then an error will occur, resulting in the process being interrupted.

Further, in the case where a plurality of MFPs are used and a key macro registered in one MFP is executed on another MFP, if the process according to the key macro includes a process that uses an option that can be installed only in the MFP in which the key macro was registered, an error will occur upon the stage where the process using the option is executed being reached, resulting in the process being interrupted.

### SUMMARY OF THE INVENTION

It is an object of the present invention to provide an image forming apparatus and a control method for the same, which is capable of improving the usability of a key macro function provided therein, as well as a control program for implementing the method, and a storage medium storing the program.

To attain the above object, in a first aspect of the present invention there is provided an image forming apparatus having a key macro function, comprising a plurality of operating keys that respectively input a plurality of pieces of operation information, a key macro registering device that registers the inputted plurality of pieces of operation information in association with a single key selected from keys including the operating keys, as a key macro, and a determining device that determines whether a process according to the registered key macro is executable, before the process according to the registered key macro is executed.

According to the above construction, since it is determined whether a process according to a registered key macro is executable before the process is executed, the occurrence of errors can be avoided and the usability of the key macro function provided in the image forming apparatus can be improved.

Preferably, the image forming apparatus further comprises a display device that displays a macro key corresponding to the registered key macro, and the display device is operable when the process according to the registered key macro is not executable, to change a display of the macro key corresponding to the registered key macro.

According to the above construction, it is possible to inform the user beforehand of whether or not the process according to the registered key macro is not executable in an easily understandable manner, thereby further improving the usability of the key macro function.

More preferably, the display device changes the display based on whether the process according to the registered key macro is not executable due to an easily remediable situation.

According to the above construction, it is possible to inform the user of the reason why the process for the registered key macro is not executable in an easily understandable manner, thereby further improving the usability of the key macro function.

More preferably, the display device displays a reason why the process according to the registered key macro is not executable.

According to the above construction, it is possible to further improve the usability of the key macro function.

To attain the above object, in a second aspect of the present invention there is provided a control method for an image forming apparatus having a key macro function, the control method comprising a key macro registering step of registering, as a key macro, a plurality of pieces of operation information inputted by a plurality of operating keys that respectively input the plurality of pieces of operation information, in association with a single key selected from keys including the operating keys, and a determining step of determining whether a process according to the registered key macro is executable, before the process according to the registered key macro is executed.

Preferably, the control method further comprises a display step of displaying a macro key corresponding to the registered key macro, and when the process according to the registered key macro is not executable, in the display step, a display of the macro key corresponding to the registered key macro is changed.

More preferably, in the display step, the display is changed based on whether the process according to the registered key macro is not executable due to an easily remediable situation.

More preferably, in the display step, a reason why the process according to the registered key macro is not executable is displayed.

To attain the above object, in a third aspect of the present invention there is provided a control program for an image forming apparatus having a key macro function, the control program comprising a key macro registering module for registering, as a key macro, a plurality of pieces of operation information inputted by a plurality of operating keys that respectively input the plurality of pieces of operation information, in association with a single key selected from keys including the operating keys, and a determining module for determining whether a process according to the registered key macro is executable, before the process according to the registered key macro is executed.

To attain the above object, in a fourth aspect of the present invention there is provided a computer-readable storage medium storing the control program according to the third aspect of the present invention.

The above and other objects, features, and advantages of the invention will become more apparent from the following detailed description taken in conjunction with the accompanying drawings.

### BRIEF DESCRIPTION OF THE DRAWINGS

FIG. 1A is a block diagram schematically showing the construction of a system including MFPs as image forming apparatuses according to an embodiment of the present invention;

FIG. 1B is a block diagram showing one example of the internal hardware construction of one of the MFPs appearing in FIG. 1A;

FIG. 2 is a view schematically showing the operation panel layout of an operating section of one of the MFPs appearing in FIG. 1A;

FIG. 3 is a flowchart showing a macro recall key display control process executed by one of the MFPs appearing in FIG. 1A;

FIG. 4 is a view showing a macro mode window displayed in a step S302 in FIG. 3;

FIG. 5 is a diagram useful in explaining a resource list used in a step S303 in FIG. 3;

FIG. 6 is a view showing a macro recall window displayed in a step S305 in FIG. 3;

FIG. 7 is a view showing a first example of the macro recall window appearing in FIG. 6 after a display is changed in a step S307 in FIG. 3;

FIG. 8 is a view showing an error message displayed in a step S310 in FIG. 3;

FIG. 9 is a view showing a second example of the macro recall window appearing in FIG. 6 after a display is changed in a step S308 in FIG. 3; and

FIG. 10 is a view showing another display example of the operating section appearing in FIG. 2 for a case where macro recall keys are displayed in an initial state.

### DETAILED DESCRIPTION OF THE PREFERRED EMBODIMENTS

The present invention will now be described in detail below with reference to the drawings showing preferred embodiments thereof.

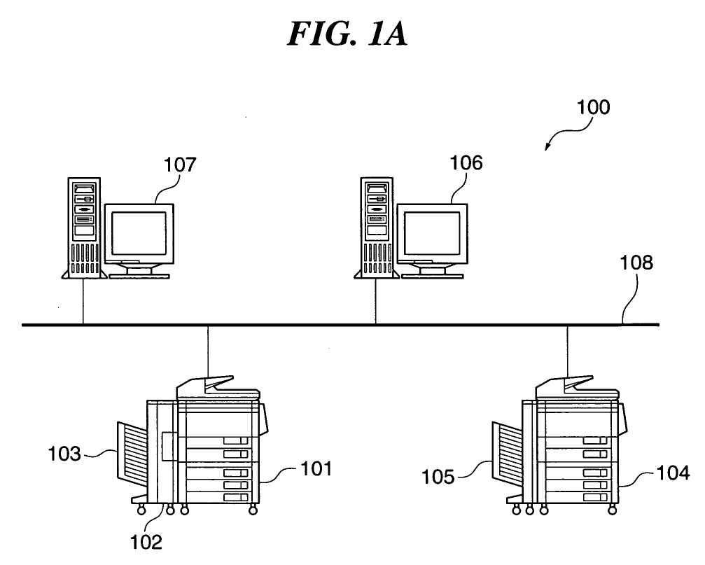

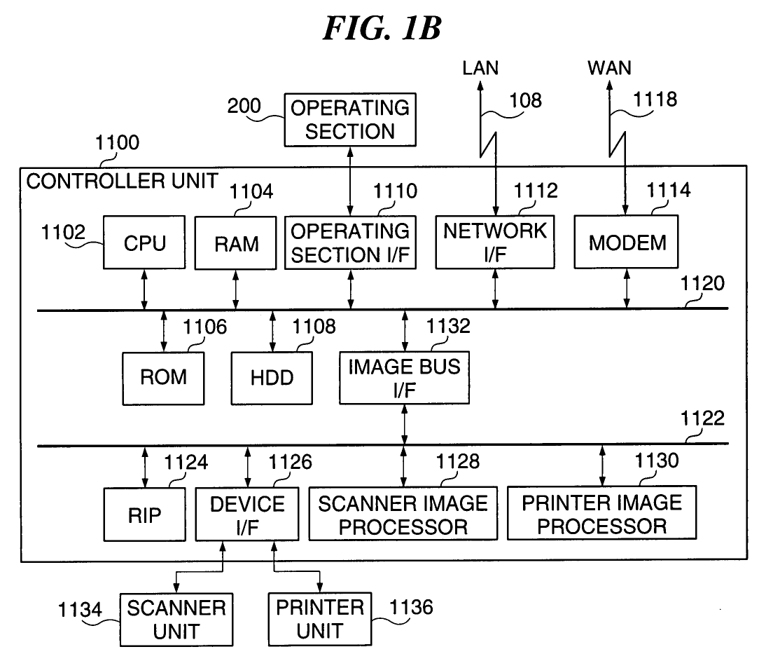

FIG. 1A is a block diagram schematically showing the construction of a system including MFPs as image forming apparatuses according to an embodiment of the present invention.

As shown in FIG. 1A, a system 100 includes multi function printers (MFPs) 101, 104 as image forming apparatuses, a file server 106, and a personal computer (PC) 107, with such appliances being interconnected via a local area network (LAN) 108. The LAN 108 is connected via a gateway, not shown, to the Internet.

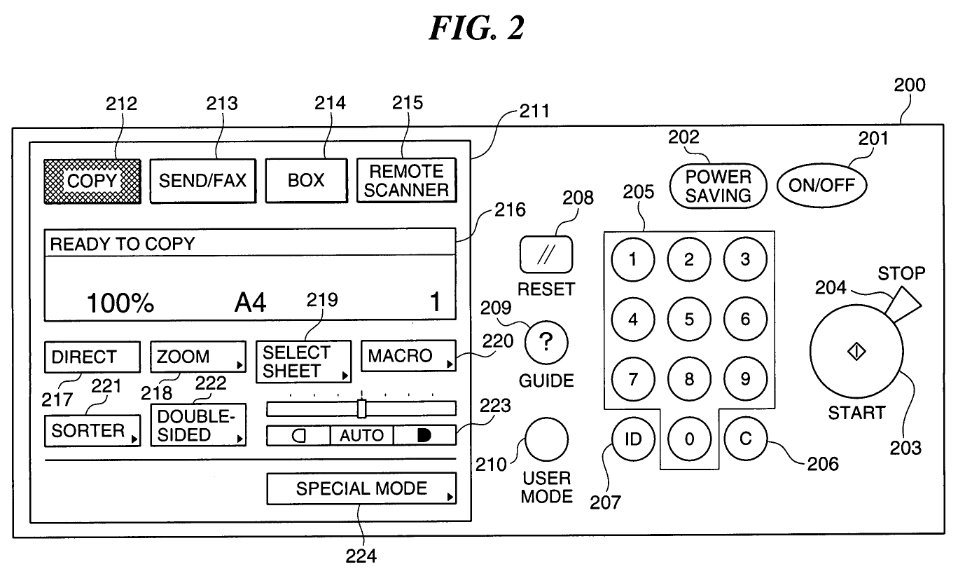

The MFP 101 includes a puncher unit 102 for punching holes for filing in sheets printed by the MFP 101, a finisher 103 that discharges the sheets printed by the MFP 101 in units of copies or pages to respective trays and carries out stapling processing, and an operating section shown in FIG. 2, described later. The MFP 104 includes a finisher 105 that is the same as the finisher 103 and an operating section that is the same as the operating section shown in FIG. 2, and also has a hardware configuration that is the same as the hardware configuration shown in FIG. 1B.

The file server 106 and the PC 107 can use the MFPs 101, and 104 as printers or scanners.

FIG. 1B is a block diagram showing one example of the internal hardware configuration of the MFP 101 appearing in FIG. 1A.

In FIG. 1B, a controller unit 1100 is connected to a scanner unit 1134 as an image input device and a printer unit 1136 as an image output device, and inputs and outputs image information and device information by connecting to the LAN 108 and a wide area network (WAN) 1118 as one example of a public network.

A central processing unit (CPU) 1102 controls the entire system. A random access memory (RAM) 1104 serves as a system work memory for operations of the CPU 1102 and also serves as an image memory for temporarily storing image data. A read-only memory (ROM) 1106 is a boot ROM storing a boot program for the system. A hard disk drive (HDD) 1108 stores system software, image data, key macros (described later), and the like.

The operating section I/F 1110 is an interface section for the operating section 200 with a touch panel shown in FIG. 2, described later, and outputs image data to be displayed by the operating section 200 to the operating section 200. In addition, the operating section I/F 1110 transfers information inputted by the user of the system 100 from the operating section 200 to the CPU 1102. A network I/F 1112 connects to the LAN 108 and inputs and outputs information.

A modem 1114 connects to the WAN 1118 and inputs and outputs information.

The above devices are connected to a system bus 1120.

An image bus I/F 1132 is a bus bridge that connects the system bus 1120 to an image bus 1122, which transfers image data at high speed, and converts the data structure. The following devices are connected to the image bus 1122.

A raster image processor (RIP) 1124 expands PDL (Page Description Language) code into a bitmap image. A device I/F 1126 connects the scanner unit 1134 and the printer unit 1136 that are image input/output devices, to the controller unit 1100, and carries out a synchronous/asynchronous conversion of image data. A scanner image processing section 1128 carries out correction, processing, and editing on input image data. A printer image processing section 1130 carries out printer correction, resolution conversion, and the like on output image data to be printed out.

FIG. 2 is a view schematically showing the operation panel layout of the operating section of the MFP 101 appearing in FIG. 1A.

As shown in FIG. 2, the operating section 200 includes a power key for turning a power supply on and off, a power saving key 202 for switching to a low power consumption mode, a start key 203 for starting a job, a stop key 204 for stopping a job during execution thereof, a ten key 205 for inputting numerical parameters of a job, such as a number of copies, a clear key 206 for clearing inputted parameters, an ID key 207 for switching to a mode where a personal identification number (PIN) for restricting the users who can use the MFP 101 is inputted, a reset key 208 for resetting set values and parameters to an initial state, a guide key 209 for switching to a guide mode showing operating instructions, a user mode key 210 for making personal settings, and a liquid crystal display section 211 for displaying functions of the MFP 101 in a menu.

The liquid crystal display section 211 displays, in an initial state, a copy mode key 212 for setting copying, a send/FAX mode key 213 for setting transmission of a scanned image by electronic mail or facsimile, a box mode key 214 for setting storage of scanned image data in the HDD 1108 and fetching image data stored in advance in the HDD 1108 and printing, a remote scanner mode key 215 for setting use of the MFP 101 as a scanner via the LAN 108, a state display window 216 that displays the state of the MFP 101, for example, a copy mode, copy magnification, sheet size, and number of copies; a direct key 217 for setting the copy magnification at “direct” (100% magnification), a zoom key 218 for setting the copy magnification at any of a number of predetermined values (25, 50, 61, 70, 81, 86, 115, 122, 141, 200, and 400% magnifications), a sheet selection key 219 for setting a sheet size for printing; a macro key 220 for entering a macro mode for registering and recalling key macros, a sorter key 221 for making sorting settings such as whether to sort in copy units or page units on respective trays of the finisher 103 and settings such as whether to carry out the stapling processing, a double-sided mode setting key 222 for setting double-sided printing; a density adjustment bar 223 for adjusting print density; and a special mode key 224 for setting “2 in 1” printing where two pages are reduced and laid out on one page, bookbinding with folding in half, copy instructions for different sizes, monochrome/full-color printing, image quality adjustment, designated area printing, and the like.

The liquid crystal display section 211 has a transparent touch panel (not shown) provided on a surface thereof. The touch panel detects whether menus or keys displayed on the liquid crystal display section 211 have been touched, and input the operations to the MFP 101.

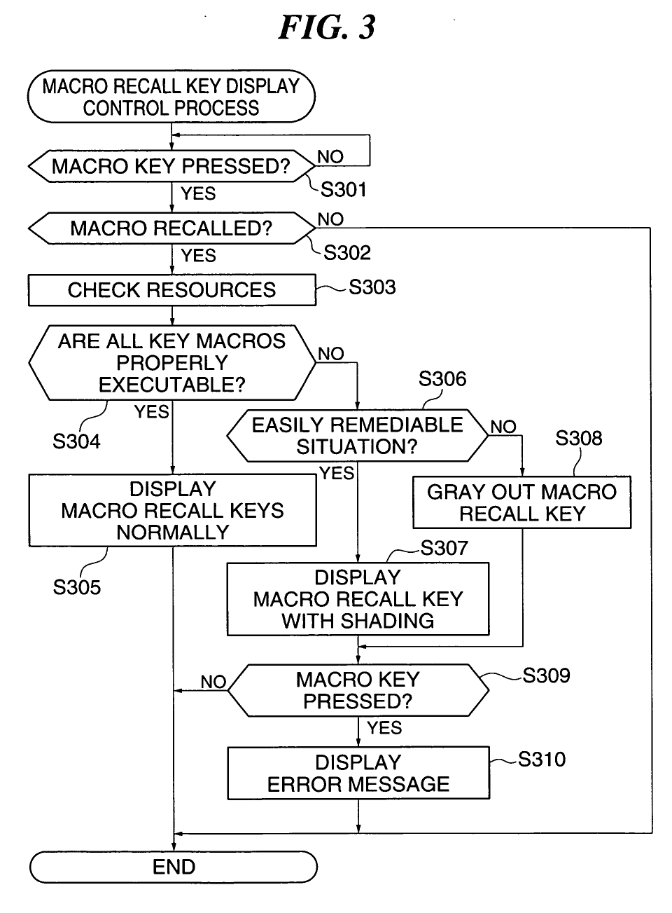

FIG. 3 is a flowchart showing the procedure of a macro recall key display control process executed by the MFP 101 appearing in FIG. 1A.

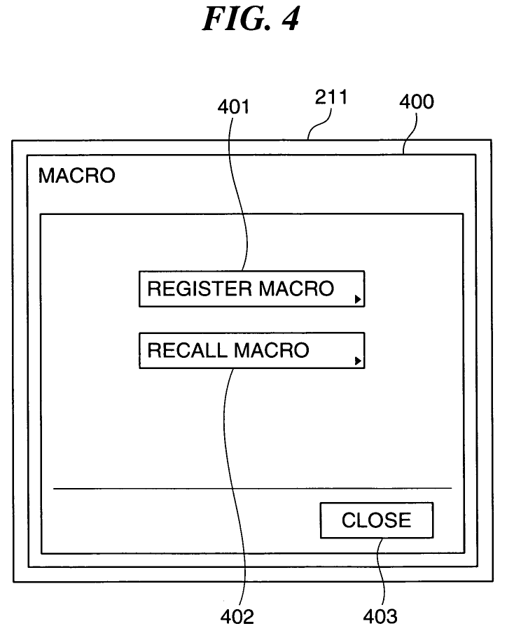

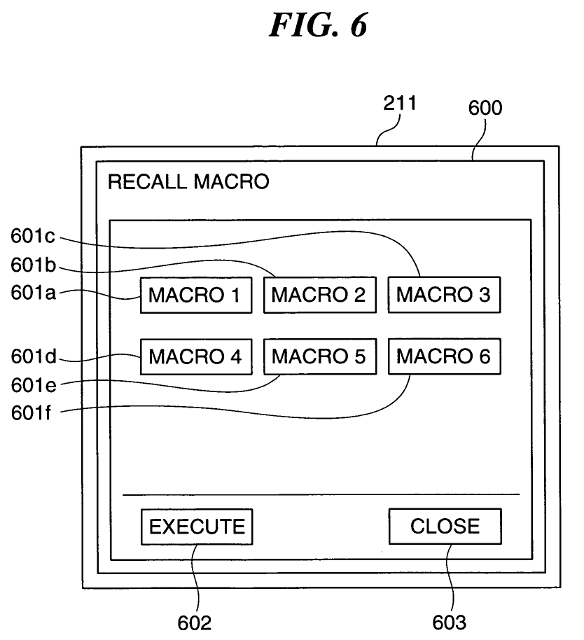

As shown in FIG. 3, when the macro key 220 is pressed (“YES” to a step S301), the MFP 101 switches to the macro mode and the liquid crystal display section 211 displays a macro mode window 400 (see FIG. 4) composed of a macro registration mode key 401 for registering a key macro, a macro recall mode key 402 for recalling a registered key macro, and a close key 403 for terminating the macro mode. When the macro registration mode key 401 is pressed, the MFP 101 switches to a macro registration mode. When the user operates any keys of the operating section 200 during the macro registration mode, the controller unit 1100 can store the types and order of operation of the operated keys in the HDD 1108 as a key macro. Next, the stored key macro is assigned to one of macro recall keys 601a to 601f appearing in FIG. 6 and registered in association therewith.

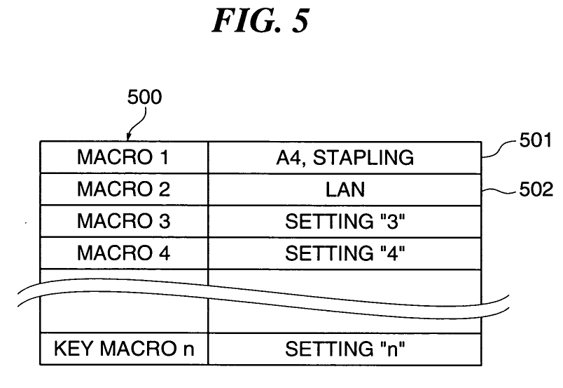

In a step S302, it is determined whether or not the macro recall mode key 402 has been pressed. When the macro recall mode key 402 has been pressed, resources of the MFP 101 and the like are checked based on a resource list 500 (see FIG. 5) in which n registered key macros numbered 1 to n are listed together with setting items, for example, resource names, required when executing the respective key macros (step S303).

For example, in the step S303, it is checked whether or not “A4 sheets” and “stapling” shown in a field 501 can be used for the key macro “1”, and it is checked whether or not “LAN” shown in a field 502 can be used for the key macro “2”.

Next, in the next step S304, based on the result of the checking in the step S303, it is determined whether or not all the registered key macros can be properly executed. When all of the key macros can be properly executed, the MFP 101 switches to a macro recall mode, and the liquid crystal display section 211 displays a macro recall window 600 (see FIG. 6) (step S305), and the present process is terminated.

The macro recall window 600 is composed of a plurality of macro recall keys (in FIG. 6, the macro recall keys 601a to 601f) that respectively correspond to the n key macros registered in the resource list 500 shown in FIG. 5, an execute key 602 for executing a key macro corresponding to a macro recall key out of the n macro recall keys that has been pressed (selected), and a close key 603 for terminating the macro recall mode.

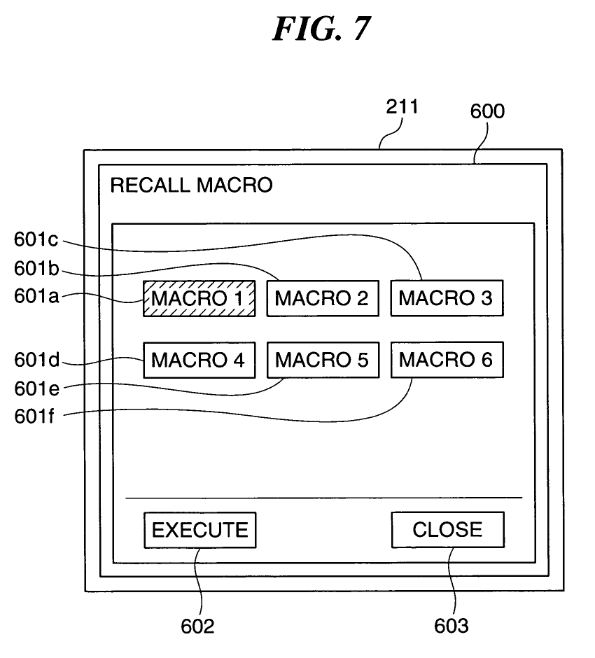

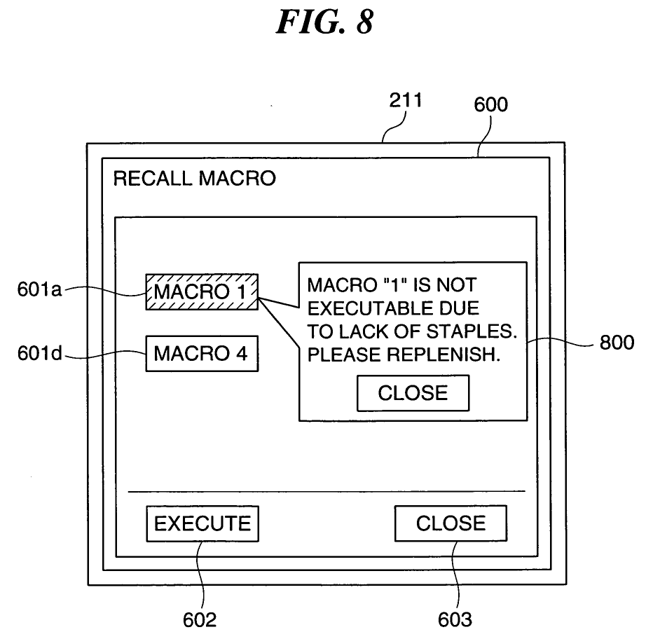

When it is determined in the step S304 that one or more key macros are not executable, for example, where the process according to the key macro “1” is not executable due to lack of staples, it is determined whether or not the situation can be easily remedied (step S306). When the process according to the key macro “1” is not executable due to an easily remediable situation such as lack of staples, the liquid crystal display section 211 highlights, for example, by shading the macro recall key 601a corresponding to the key macro “1” (see FIG. 7), to display that the process according to the key macro “1” is not executable due to an easily remediable situation (step S307). It is then determined whether or not the highlighted macro recall key 601a has been pressed (step S309), and when the macro recall key 601a has been pressed, the liquid crystal display section 211 displays an error message 800 (see FIG. 8) showing the cause of the error to notify that the process according to the key macro “1” will become executable if staples are replenished (step S310), and the present process is terminated. Note that in the case where the process according to the key macro “1” corresponding to the macro recall key 601a is not executable due to an easily remediable situation, as shown in FIG. 8, it may be configured such that execution of the process according to the key macro “1” is started in response to the execute key 602 being pressed.

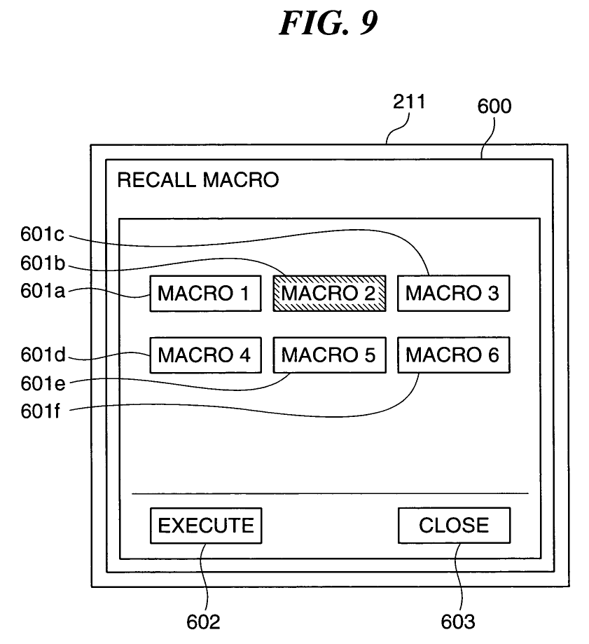

It is determined in the step S306 that the situation cannot be easily remedied, for example, when a process according to the key macro “2” that uses the LAN is not executable due to a network failure, the liquid crystal display section 211 highlights, for example, by graying out the macro recall key 601b corresponding to the key macro “2” (see FIG. 9), to display that the process according to the key macro “2” is not executable due to a situation that cannot be easily remedied (step S308). It is then determined whether or not the highlighted macro recall key 601b has been pressed (step S309), and when the macro recall key 601b has been pressed, in the same way as in FIG. 8, the liquid crystal display section 211 displays the cause “network failure” as the error message 800 to notify that the process according to the key macro “2” is not executable (step S310), and the present process is terminated. Note that since the key macro corresponding to macro recall key 601b is not executable due to a situation that cannot be easily remedied, it may be configured such that in a screen like that of FIG. 8, the execute key 602 is grayed out so that no processing can be carried out in response to the execute key 602 being pressed.

Also, if the macro recall key display control process shown in FIG. 3 is not executed, and a key macro that is registered in the MFP 101 and executes a process using the puncher unit 102 as an option is copied to the MFP 104, since the MFP 104 is not equipped with a puncher unit, an error will occur when the process according to the copied key macro is executed, and the user will find out that the key macro is not executable, only after the error has occurred.

However, if the MFP 104 executes the macro recall key display control process shown in FIG. 3, the lack of a puncher unit will be detected before the process according to the key macro is executed, and therefore the user can be notified in advance that the process according to the key macro is not executable.

According to the process shown in FIG. 3, when a process according to a registered key macro is not executable (“YES” to the step S304), but the situation can be easily remedied (“YES” to the step S306), the corresponding macro recall key (601a) is displayed with shading (step S307), and therefore the user can know in advance whether or not the process according to a registered key macro is executable and, errors can be avoided during execution of the process according to the key macro, which improves the usability of the key macro function.

Also, although in the present embodiment, macro recall keys corresponding to key macros which are not executable due to easily remediable situations are shaded and macro recall keys corresponding to key macros which are not executable due to not easily remediable situations are grayed out, the present invention is not limited to this, and any display that can distinguish between the case where a key macro is properly executable, the case where a key macro is not executable due to an easily remediable situation, and the case where a key macro is not executable due to a not easily remediable situation may be used.

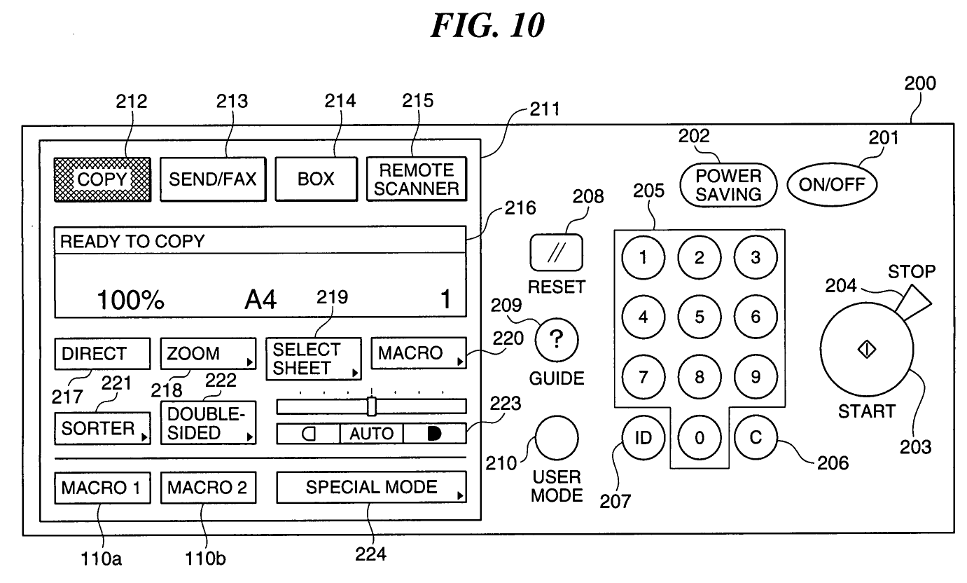

Further, although in the present embodiment, the liquid crystal display section 211 displays the macro recall keys 601a to 601f after the macro key 220 is pressed and then the macro recall mode key 402 is pressed, alternatively, as shown in FIG. 10, it may be configured such that the liquid crystal display section 211 displays macro recall keys 110a and 110b in the initial state.

In this case, a resource check is carried out in the same way as the step S303 appearing in FIG. 3 at fixed time intervals measured using an internal timer or the like incorporated in the MFP 101. When as a result of the resource check, at least one of key macros corresponding to the macro recall keys 100a and 110b is not executable, the display of such macro recall key is changed. In this way, the user can immediately know whether or not the processes according to the registered key macros are executable, and errors can be avoided during execution of a key macro, thereby improving the usability of the key macro function.

In the case where the macro recall keys 110a and 110b are displayed on the liquid crystal display section 211 shown in FIG. 10, instead of using the internal timer, a resource check may be carried out in the same way as in the step S303 appearing in FIG. 3 whenever the status of the MFP 101 changes.

It is to be understood that the object of the present invention may also be accomplished by supplying a system or an apparatus with a storage medium (or recording medium) in which a program code of software which realizes the functions of the above described embodiment is stored, and causing a computer (or CPU or MPU) of the system or apparatus to read out and execute the program code stored in the storage medium.

In this case, the program code itself read out from the storage medium realizes the functions of the above described embodiment, and hence the program code and the storage medium in which the program code is stored constitute the present invention.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

Further, the above program has only to realize the functions of the above described embodiment on a computer, and the form of the program may be an object code, a program executed by an interpreter, or script data supplied to an OS.

Examples of the storage medium for supplying the program code include a RAM, an NV-RAM, a floppy (registered trademark) disk, a hard disk, a magnetic-optical disk, a CD-ROM, an MO, a CD-R, a CD-RW, a DVD (a DVD-ROM, a DVD-RAM, a DVD−RW, or a DVD+RW), a magnetic tape, a nonvolatile memory card, and a ROM. Alternatively, the program may be supplied by downloading from another computer, a database, or the like, not shown, connected to the Internet, a commercial network, a local area network, or the like.

### CROSS REFERENCE TO RELATED APPLICATION

This application claims priority from Japanese Patent Application No. 2004-242832 filed Aug. 23, 2004, which is hereby incorporated by reference herein.

What is claimed is:

1. An image forming apparatus having a key macro function, comprising:
a plurality of operating keys that respectively input a piece of operation information;
a key macro register that registers the inputted at least one piece of operation information as a key macro; and
a determining unit that determines whether a process according to the registered key macro is executable, before the process according to the registered key macro is executed.

2. An image forming apparatus according to claim 1, further comprising a display unit that displays a macro key corresponding to the registered key macro, and wherein said display unit is operable when the process according to the registered key macro is not executable, to change a display of the macro key corresponding to the registered key macro.

3. An image forming apparatus according to claim 2, wherein said display unit changes the display based on whether the process according to the registered key macro is not executable due to an easily remediable situation.

4. An image forming apparatus according to claim 2, wherein said display unit displays a reason why the process according to the registered key macro is not executable.

5. A control method for an image forming apparatus having a key macro function, the control method comprising:
a key macro registering step of registering, as a key macro, at least one piece of operation information inputted by at least one of a plurality of operating keys that respectively input a piece of operation information; and
a determining step of determining whether a process according to the registered key macro is executable, before the process according to the registered key macro is executed.

6. A control method according to claim 5, further comprising a display step of displaying a macro key corresponding to the registered key macro, and wherein when the process according to the registered key macro is not executable, in said display step, a display of the macro key corresponding to the registered key macro is changed.

7. A control method according to claim 6, wherein in said display step, the display is changed based on whether the process according to the registered key macro is not executable due to an easily remediable situation.

8. A control method according to claim 6, wherein in said display step, a reason why the process according to the registered key macro is not executable is displayed.

9. A control program for an image forming apparatus having a key macro function, the control program comprising:
a key macro registering module for registering, as a key macro, at least one piece of operation information inputted by at least one of a plurality of operating keys that respectively input a piece of operation information; and
a determining module for determining whether a process according to the registered key macro is executable, before the process according to the registered key macro is executed.

10. A computer-readable storage medium storing a control program according to claim 9.
